(19) United States
(12) Patent Application Publication
(10) Pub. No.: US 2025/0341175 A1
(43) Pub. Date: Nov. 6, 2025

(54) GAS TURBINE ENGINE WITH HIGH SPEED LOW PRESSURE TURBINE SECTION AND BEARING SUPPORT FEATURES

(71) Applicant: RTX CORPORATION, Farmington, CT (US)

(72) Inventors: Frederick M. Schwarz, Glastonbury, CT (US); Gabriel L. Suciu, Glastonbury, CT (US); William K. Ackermann, East Hartford, CT (US); Daniel Bernard Kupratis, Wallingford, CT (US); Michael E. McCune, Colchester, CT (US)

(21) Appl. No.: 19/269,241

(22) Filed: Jul. 15, 2025

Related U.S. Application Data
(63) Continuation of application No. 18/420,862, filed on Jan. 24, 2024, now Pat. No. 12,366,179.
Application No. 18/420,862 is a continuation of application No. 18/104,375, filed on Feb. 1, 2023, now Pat. No. 11,913,349.
Application No. 18/104,375 is a continuation of application No. 16/227,271, filed on Dec. 20, 2018, now Pat. No. 11,598,223.
Application No. 16/227,271 is a continuation of application No. 15/478,706, filed on Apr. 4, 2017, now Pat. No. 10,287,914.
Application No. 15/478,706 is a continuation-in-part of application No. 13/446,510, filed on Apr. 13, 2012, now Pat. No. 9,611,859.
Application No. 13/446,510 is a continuation-in-part of application No. 13/363,154, filed on Jan. 31, 2012, now abandoned.
(60) Provisional application No. 61/619,124, filed on Apr. 2, 2012.

(51) Int. Cl. F01D 25/16; F01D 15/12; F02C 3/107; F02C 7/06; F02C 7/20; F02C 7/36; F02K 3/06

(52) U.S. Cl. CPC F01D 25/164; F01D 15/12; F01D 25/162; F02C 3/107; F02C 7/06; F02C 7/20; F02C 7/36; F02K 3/06; F05D 2220/32; F05D 2240/60; F05D 2260/40311

(57) ABSTRACT

A gas turbine engine according to an example of the present disclosure includes, among other things, a propulsor, a compressor section, a turbine section and an epicyclic gear system. The turbine section includes a first turbine and a second turbine. The second turbine drives the propulsor through the epicyclic gear system. The epicyclic gear system includes a carrier. A drive shaft interconnects the carrier and the propulsor. A frame supports at least a portion of the drive shaft. A flexible support at least partially supports the gear system relative to an engine static structure.

### CROSS-REFERENCE TO RELATED APPLICATION

This application is a continuation of application is a continuation of U.S. patent application Ser. No. 18/420,862 filed Jan. 24, 2024, which is a continuation of application is a continuation of U.S. patent application Ser. No. 18/104,375 filed Feb. 1, 2023, which is a continuation of U.S. patent application Ser. No. 16/227,271 filed Dec. 20, 2018, which is a continuation of U.S. patent application Ser. No. 15/478,706 filed Apr. 4, 2017, which is a continuation-in-part of U.S. patent application Ser. No. 13/446,510 filed Apr. 13, 2012, which claims priority to U.S. Provisional Application No. 61/619,124, filed Apr. 2, 2012, and is a continuation-in-part of U.S. patent application Ser. No. 13/363,154, filed on Jan. 31, 2012 and entitled “Gas Turbine Engine With High Speed Low Pressure Turbine Section.”

### BACKGROUND OF THE INVENTION

This application relates to a gas turbine engine wherein the low pressure turbine section is rotating at a higher speed and centrifugal pull stress relative to the high pressure turbine section speed and centrifugal pull stress than prior art engines.

Gas turbine engines are known, and typically include a fan delivering air into a low pressure compressor section. The air is compressed in the low pressure compressor section, and passed into a high pressure compressor section. From the high pressure compressor section the air is introduced into a combustion section where it is mixed with fuel and ignited. Products of this combustion pass downstream over a high pressure turbine section, and then a low pressure turbine section.

Traditionally, on many prior art engines the low pressure turbine section has driven both the low pressure compressor section and a fan directly. As fuel consumption improves with larger fan diameters relative to core diameters it has been the trend in the industry to increase fan diameters. However, as the fan diameter is increased, high fan blade tip speeds may result in a decrease in efficiency due to compressibility effects. Accordingly, the fan speed, and thus the speed of the low pressure compressor section and low pressure turbine section (both of which historically have been coupled to the fan via the low pressure spool), have been a design constraint. More recently, gear reductions have been proposed between the low pressure spool (low pressure compressor section and low pressure turbine section) and the fan.

### SUMMARY

A gas turbine engine according to an example of the present disclosure includes a turbine section that has a fan drive turbine and a second turbine, and a gear system with a gear reduction. The fan drive turbine drives a fan through the gear system, and a gear ratio of the gear reduction being greater than 2. A mid-turbine frame is positioned intermediate the fan drive turbine and the second turbine. The fan drive turbine has a first exit area at a first exit point and is rotatable at a first speed. The second turbine has a second exit area at a second exit point and is rotatable at a second speed, and the second speed is faster than the first speed. A first performance quantity is defined as the product of the first speed squared and the first area, a second performance quantity is defined as the product of the second speed squared and the second area, and a performance ratio of the first performance quantity to the second performance quantity is between 0.8 and 1.5.

In a further embodiment of any of the foregoing embodiments, the fan drive turbine is a 3-stage to 6-stage turbine, and the second turbine is a 2-stage turbine.

In a further embodiment of any of the foregoing embodiments, the fan drive turbine includes an inlet, an outlet, and a fan drive turbine pressure ratio greater than 5. The fan drive turbine pressure ratio is a ratio of a pressure measured prior to the inlet as related to a pressure at the outlet prior to any exhaust nozzle.

In a further embodiment of any of the foregoing embodiments, a bypass ratio is greater than 10. The fan includes a plurality of fan blades, a fan pressure ratio across the fan blades being less than 1.45, measured across the fan blades alone.

A further embodiment of any of the foregoing embodiments include a compressor section including a low pressure compressor having 3 stages.

In a further embodiment of any of the foregoing embodiments, the mid-turbine frame includes a guide vane positioned intermediate the fan drive turbine and the second turbine.

In a further embodiment of any of the foregoing embodiments, the first speed is greater than 10,000 RPM.

In a further embodiment of any of the foregoing embodiments, the second speed is greater than 20,000 RPM.

In a further embodiment of any of the foregoing embodiments, the fan has fewer than 26 fan blades, and the performance ratio is greater than or equal to 1.0.

A further embodiment of any of the foregoing embodiments includes a compressor section including a low pressure compressor, the fan and the low pressure compressor being rotatable at a common speed.

In a further embodiment of any of the foregoing embodiments, the fan drive turbine and the second turbine are rotatable in opposed directions. The mid-turbine frame includes a guide vane positioned intermediate the fan drive turbine and the second turbine, and the guide vane is an air turning guide vane.

In a further embodiment of any of the foregoing embodiments, the mid-turbine frame has a first bearing supporting a first shaft rotatable with the fan drive turbine in an overhung manner.

In a further embodiment of any of the foregoing embodiments, the mid-turbine frame includes a plurality of airfoils in a core airflow path.

In a further embodiment of any of the foregoing embodiments, the second speed is greater than twice the first speed.

In a further embodiment of any of the foregoing embodiments, the fan blades have a fan tip speed of less than 1150 ft/second, and the gear system is a planetary gear system.

A further embodiment of any of the foregoing embodiments includes a compressor section including a low compressor having 3 stages.

A further embodiment of any of the foregoing embodiments includes a fan drive shaft interconnecting the gear system and the fan. A frame supports at least a portion of the fan drive shaft. The frame defines a frame transverse stiffness. A flexible support at least partially supports the gear system. The flexible support defines a support transverse stiffness with respect to the frame transverse stiffness, and the support transverse stiffness is less than about 50% of the frame transverse stiffness.

A further embodiment of any of the foregoing embodiments includes a compressor section including a first compressor, and the gear reduction is positioned between the fan drive turbine and the first compressor such that the fan and the first compressor are rotatable at a common speed.

A further embodiment of any of the foregoing embodiments includes a fan drive shaft interconnecting the gear system and the fan. A frame supports at least a portion of the fan drive shaft. The frame defines a frame transverse stiffness. A flexible support at least partially supporting the gear system. The flexible support defines a support transverse stiffness with respect to the frame transverse stiffness, and the support transverse stiffness is less than about 50% of the frame transverse stiffness.

In a further embodiment of any of the foregoing embodiments, the mid-turbine frame includes a guide vane positioned intermediate the fan drive turbine and the second turbine.

In a further embodiment of any of the foregoing embodiments, the fan drive turbine and second turbine are rotatable in opposed directions, and the guide vane is an air turning guide vane.

In a further embodiment of any of the foregoing embodiments, the mid-turbine frame has a first bearing supports a first shaft rotatable with the fan drive turbine in an overhung manner.

In a further embodiment of any of the foregoing embodiments, the mid-turbine frame includes a plurality of airfoils in a core airflow path.

In a further embodiment of any of the foregoing embodiments, the performance ratio is greater than or equal to 1.0.

In a further embodiment of any of the foregoing embodiments, the second speed is greater than 20,000 RPM, and wherein the second speed is greater than twice the first speed.

In a further embodiment of any of the foregoing embodiments, the performance ratio is greater than or equal to 1.0, the second speed is greater than twice the first speed, the fan has fewer than 26 fan blades, the fan blades have a fan tip speed of less than 1150 ft/second, and the gear system is a planetary gear system.

In a further embodiment of any of the foregoing embodiments, the turbine section drives a compressor section that has a first compressor. The gear system is straddle-mounted by bearings, and the gear system is intermediate the fan drive turbine and the first compressor such that the fan and the first compressor are rotatable at a common speed.

A further embodiment of any of the foregoing embodiments include a fan drive shaft interconnecting the gear system and the fan. A frame supports at least a portion of the fan drive shaft. The frame defines a frame transverse stiffness and a frame lateral stiffness. A flexible support at least partially supports the gear system. The flexible support defines a support transverse stiffness with respect to the frame transverse stiffness and a support lateral stiffness with respect to the frame lateral stiffness. The support transverse stiffness is less than about 80% of the frame transverse stiffness. The support lateral stiffness is less than about 80% of the frame lateral stiffness.

In a further embodiment of any of the foregoing embodiments, the support transverse stiffness is less than about 50% of the frame transverse stiffness, and the support lateral stiffness is less than about 50% of the frame lateral stiffness.

In a further embodiment of any of the foregoing embodiments, the gear system is straddle-mounted by bearings.

In a featured embodiment, a turbine section of a gas turbine engine has a fan drive and second turbine sections. The fan drive turbine section has a first exit area at a first exit point and is configured to rotate at a first speed. The second turbine section has a second exit area at a second exit point and rotates at a second speed, which is faster than the first speed. A first performance quantity is defined as the product of the first speed squared and the first area. A second performance quantity is defined as the product of the second speed squared and the second area. A ratio of the first performance quantity to the second performance quantity is between about 0.5 and about 1.5. A mid-turbine frame is positioned intermediate the fan drive and second turbine sections, and has a first bearing supporting an outer periphery of a first shaft rotating with the second turbine section.

In another embodiment according to the previous embodiment, the mid-turbine frame also includes a second bearing supporting an outer periphery of a second shaft rotating with the fan drive turbine section. The second bearing supports an intermediate portion of the second spool.

In another embodiment according to any of the previous embodiments, the ratio is above or equal to about 0.8.

In another embodiment according to any of the previous embodiments, the fan drive turbine section has at least 3 stages.

In another embodiment according to any of the previous embodiments, the fan drive turbine section has up to 6 stages.

In another embodiment according to any of the previous embodiments, the second turbine section has 2 or fewer stages.

In another embodiment according to any of the previous embodiments, a pressure ratio across the fan drive turbine section is greater than about 5:1.

In another embodiment according to any of the previous embodiments, the mid-turbine frame is provided with a guide vane positioned intermediate the fan drive and second turbine sections.

In another embodiment according to any of the previous embodiments, the fan drive and second turbine sections will rotate in opposed directions. The guide vane is a turning guide vane.

In another featured embodiment, a gas turbine engine has a fan, a compressor section in fluid communication with the fan, a combustion section in fluid communication with the compressor section, and a turbine section in fluid communication with the combustion section. The turbine section includes a fan drive turbine section and a second turbine section. The fan drive turbine section has a first exit area at a first exit point and is configured to rotate at a first speed. The second turbine section has a second exit area at a second exit point and rotates at a second speed, which is higher than the first speed. A first performance quantity is defined as the product of the first speed squared and the first area. A second performance quantity is defined as the product of the second speed squared and the second area. A ratio of the first performance quantity to the second performance quantity is between about 0.5 and about 1.5. The second turbine section is supported by a first bearing in a mid-turbine frame.

In another embodiment according to the previous embodiment, the ratio is above or equal to about 0.8.

In another embodiment according to any of the previous embodiments, the compressor section includes first and second compressor sections. The fan drive turbine section and the first compressor section will rotate in a first direction. The second turbine section and the second compressor section will rotate in a second opposed direction.

In another embodiment according to any of the previous embodiments, a gear reduction is included between the fan and a shaft driven by the fan drive turbine section such that the fan will rotate at a lower speed than the fan drive turbine section.

In another embodiment according to any of the previous embodiments, the second turbine section and second compressor section are straddle-mounted by bearings supported on an outer periphery of a shaft rotating with the second compressor section and the second turbine section.

In another embodiment according to any of the previous embodiments, the mid-turbine frame further includes a second bearing supporting an outer periphery of a shaft rotating with the fan drive turbine section.

In another embodiment according to any of the previous embodiments, the second bearing supports an intermediate portion of a shaft that will rotate with the fan drive turbine section and the first compressor section.

In another featured embodiment, a gas turbine engine has a fan, a compressor section in fluid communication with the fan, a combustion section in fluid communication with the compressor section, and a turbine section in fluid communication with the combustion section. The turbine section includes fan drive and second turbine sections. The fan drive turbine section has a first exit area at a first exit point and is configured to rotate at a first speed. The second turbine section has a second exit area at a second exit point and rotates at a second speed, which is higher than the first speed. A first performance quantity is defined as the product of the first speed squared and the first area. A second performance quantity is defined as the product of the second speed squared and the second area. A ratio of the first performance quantity to the second performance quantity is between about 0.5 and about 1.5. The compressor section includes first and second compressor sections, where the fan drive turbine section and the first compressor section will rotate in a first direction and the second turbine section and the second compressor section will rotate in a second opposed direction. A gear reduction is included between the fan and the first compressor section, such that the fan will rotate at a lower speed than the fan drive turbine section, and in the second opposed direction. A gear ratio of the gear reduction is greater than about 2.3.

In another embodiment according to the previous embodiment, the ratio is above or equal to about 0.8.

In another embodiment according to any of the previous embodiments, a mid-turbine frame is positioned intermediate the fan drive and second turbine sections. The mid-turbine frame has a first bearing supporting an outer periphery of a first shaft rotating with the second turbine section.

In another embodiment according to any of the previous embodiments, the first shaft is supported on a second bearing on its outer periphery, with the second bearing mounted to static structure.

These and other features of this disclosure will be better understood upon reading the following specification and drawings, the following of which is a brief description.

### BRIEF DESCRIPTION OF THE DRAWINGS

FIG. 1 shows a gas turbine engine.

FIG. 2 schematically shows the arrangement of the low and high spool, along with the fan drive.

FIG. 3 shows a schematic view of a mount arrangement for an engine such as shown in FIGS. 1 and 2.

FIG. 4 shows another embodiment of a gas turbine engine.

FIG. 5 shows yet another embodiment of a gas turbine engine.

### DETAILED DESCRIPTION

FIG. 1 schematically illustrates a gas turbine engine 20. The gas turbine engine 20 is disclosed herein as a two-turbine turbofan that generally incorporates a fan section 22, a compressor section 24, a combustor section 26 and a turbine section 28. Alternative engines might include an augmentor section (not shown) among other systems or features. The fan section 22 drives air along a bypass flow path B while the compressor section 24 drives air along a core flow path C for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-turbine architectures.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an innermost shaft 40 that interconnects a fan 42, a low pressure (or first) compressor section 44 and a low pressure (or first) turbine section 46. Note, turbine section 46 will also be called a fan drive turbine section. The inner shaft 40 is connected to the fan 42 through a geared architecture 48 to drive the fan 42 at a lower speed than the fan drive turbine 46. The high speed spool 32 includes a more outer shaft 50 that interconnects a high pressure (or second) compressor section 52 and high pressure (or second) turbine section 54. A combustor 56 is arranged between the high pressure compressor section 52 and the high pressure turbine section 54. A mid-turbine frame 57 of the engine static structure 36 is arranged generally between the high pressure turbine section 54 and the low pressure turbine section 46. The mid-turbine frame 57 further supports bearing systems 38 in the turbine section 28. As used herein, the high pressure turbine section experiences higher pressures than the low pressure turbine section. A low pressure turbine section is a section that powers a fan 42. The inner shaft 40 and the outer shaft 50 are concentric and rotate via bearing systems 38 about the engine central longitudinal axis A which is collinear with their longitudinal axes. The high and low spools can be either co-rotating or counter-rotating.

The core airflow C is compressed by the low pressure compressor section 44 then the high pressure compressor section 52, mixed and burned with fuel in the combustor 56, then expanded over the high pressure turbine section 54 and low pressure turbine section 46. The mid-turbine frame 57 includes airfoils 59 (one shown in FIG. 1) which are in the core airflow path. The turbine sections 46, 54 rotationally drive the respective low speed spool 30 and high speed spool 32 in response to the expansion.

The engine 20 in one example is a high-bypass geared aircraft engine. The bypass ratio is the amount of air delivered into bypass path B divided by the amount of air into core path C. In a further example, the engine 20 bypass ratio is greater than about six (6), with an example embodiment being greater than ten (10), the geared architecture 48 is an cpicyclic gear train, such as a planetary gear system or other gear system, with a gear reduction ratio of greater than about 2.3 and the low pressure turbine section 46 has a pressure ratio that is greater than about 5. In some embodiments, the bypass ratio is less than or equal to about 22.0, and the gear reduction is less than or equal to about 4.5. In one disclosed embodiment, the engine 20 bypass ratio is greater than about ten (10:1), the fan diameter is significantly larger than that of the low pressure compressor section 44, and the low pressure turbine section 46 has a pressure ratio that is greater than about 5:1. In some embodiments, the low pressure turbine section 46 has a pressure ratio that is less than or equal to about 30. In some embodiments, the high pressure turbine section may have two or fewer stages. In contrast, the low pressure turbine section 46, in some embodiments, has between 3 and 6 stages. Further the low pressure turbine section 46 pressure ratio is total pressure measured prior to inlet of low pressure turbine section 46 as related to the total pressure at the outlet of the low pressure turbine section 46 prior to an exhaust nozzle. The geared architecture 48 may be an epicycle gear train, such as a planetary gear system or other gear system, with a gear reduction ratio of greater than about 2.5:1. It should be understood, however, that the above parameters are only exemplary of one embodiment of a geared architecture engine.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (“TSFC”). TSFC is the industry standard parameter of the rate of lbm of fuel being burned per hour divided by lbf of thrust the engine produces at that flight condition. “Low fan pressure ratio” is the ratio of total pressure across the fan blade alone, before the fan exit guide vanes. The low fan pressure ratio as disclosed herein according to one non-limiting embodiment is less than about 1.45, and is greater than or equal to about 1.1. “Low corrected fan tip speed” is the actual fan tip speed in ft/see divided by an industry standard temperature correction of [(Ram Air Temperature deg R)/518.7)\hat{ }0.5]. The “Low corrected fan tip speed” as disclosed herein according to one non-limiting embodiment is less than about 1150 ft/second, and is greater than or equal to about 850 ft/second. Further, the fan 42 may have 26 or fewer blades.

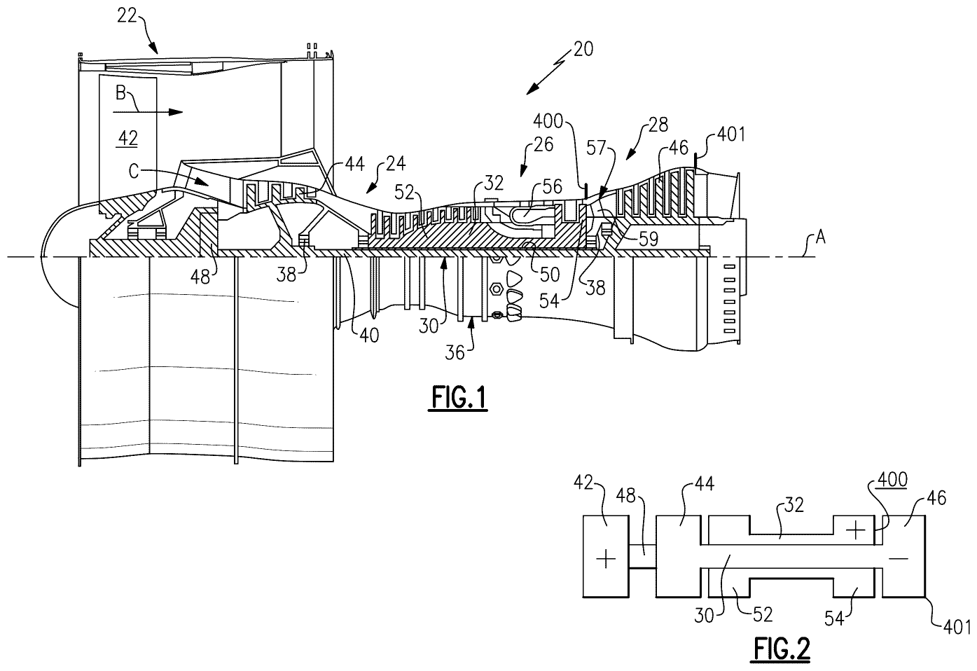

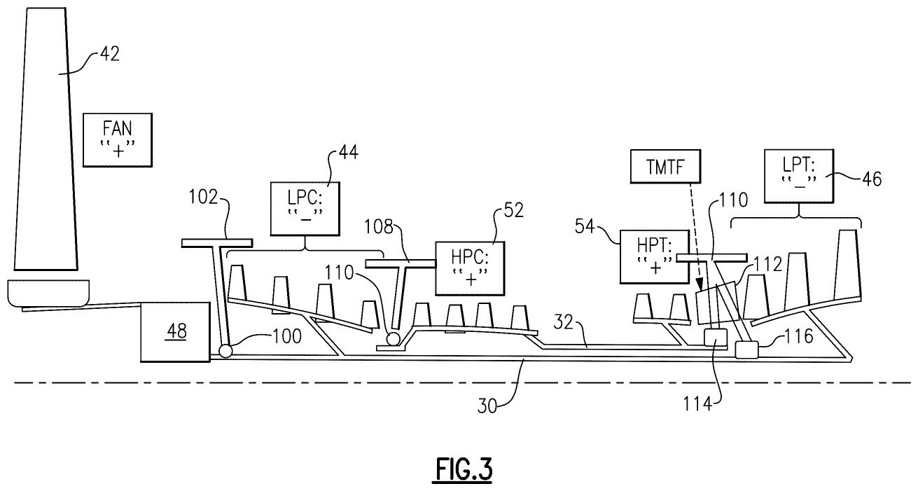

An exit area 400 is shown, in FIG. 1 and FIG. 2, at the exit location for the high pressure turbine section 54 is the annular area of the last blade of turbine section 54. An exit area for the low pressure turbine section is defined at exit 401 for the low pressure turbine section and is the annular area defined by the blade of that turbine section 46. As shown in FIG. 2, the turbine engine 20 may be counter-rotating. This means that the low pressure turbine section 46 and low pressure compressor section 44 rotate in one direction (“−”), while the high pressure spool 32, including high pressure turbine section 54 and high pressure compressor section 52 rotate in an opposed (“+”) direction. The gear reduction 48, which may be, for example, an epicyclic transmission (e.g., with a sun, ring, and planet gears), is selected such that the fan 42 rotates in the same direction (“+”) as the high spool 32. With this arrangement, and with the other structure as set forth above, including the various quantities and operational ranges, a very high speed can be provided to the low pressure spool. Low pressure turbine section and high pressure turbine section operation are often evaluated looking at a performance quantity which is the exit area for the turbine section multiplied by its respective speed squared. This performance quantity (“PQ”) is defined as:

$$P {Q}_{ltp} = ( {A}_{lpt} \times {V}_{lpt}^{2} ) \qquad Equation 1$$

$$P {Q}_{hpt} = ( {A}_{hpt} \times {V}_{hpt}^{2} ) \qquad Equation 2$$

where Aₗₚₜ is the area of the low pressure turbine section at the exit thereof (e.g., at 401), where Vₗₚₜ is the speed of the low pressure turbine section, where Aₕₚₜ is the area of the high pressure turbine section at the exit thereof (e.g., at 400), and where Vₕₚₜ is the speed of the low pressure turbine section.

Thus, a ratio of the performance quantity for the low pressure turbine section compared to the performance quantify for the high pressure turbine section is:

$$( {A}_{lpt} \times {V}_{lpt}^{2} ) / ( {A}_{hpt} \times {V}_{hpt}^{2} ) = {PQ}_{ltp /} {PQ}_{hpt} \qquad Equation 3$$

In one turbine embodiment made according to the above design, the areas of the low and high pressure turbine sections are 557.9 in² and 90.67 in², respectively. Further, the speeds of the low and high pressure turbine sections are 10179 rpm and 24346 rpm, respectively, such that the speed of the high pressure turbine section is more than twice the speed of the low pressure section, and such that the speeds of the low and high pressure turbine sections being greater than 10000 and 20000 rpm, respective. Thus, using Equations 1 and 2 above, the performance quantities for the low and high pressure turbine sections are:

$${PQ}_{ltp} = ( {A}_{lpt} \times {V}_{lpt}^{2} ) = ( 557.9 {in}^{2} ) {( 10179 rpm )}^{2} = 5.78051576739 \times {10}^{10} {in}^{2} {rpm}^{2} \qquad Equation 1$$

$${PQ}_{hpt} = ( {A}_{hpt} \times {V}_{hpt}^{2} ) = ( 90.67 {in}^{2} ) {( 24346 rpm )}^{2} = 5.374262200972 \times {10}^{10} {in}^{2} {rpm}^{2} \qquad Equation 2$$

and using Equation 3 above, the ratio for the low pressure turbine section to the high pressure turbine section is:

$$Ratio = {PQ}_{ltp /} P {Q}_{hpt} = 57805157 673.9 {in}^{2} {rpm}^{2} / 5.374262200972 \times {10}^{10} {in}^{2} {rpm}^{2} = 1.075$$

In another embodiment, the ratio was about 0.5 and in another embodiment the ratio was about 1.5. With PQᵢₜₚ/PQₕₚₜ ratios in the 0.5 to 1.5 range, a very efficient overall gas turbine engine is achieved. More narrowly, PQᵢₜₚ/PQₕₚₜ ratios of above or equal to about 0.8 are more efficient. Even more narrowly, PQᵢₜₚ/PQₕₚₜ ratios above or equal to 1.0 are even more efficient. As a result of these PQᵢₜₚ/PQₕₚₜ ratios, in particular, the turbine section can be made much smaller than in the prior art, both in diameter and axial length. In addition, the efficiency of the overall engine is greatly increased.

The low pressure compressor section is also improved with this arrangement, and behaves more like a high pressure compressor section than a traditional low pressure compressor section. It is more efficient than the prior art, and can provide more compression in fewer stages. The low pressure compressor section may be made smaller in radius and shorter in length while contributing more toward achieving the overall pressure ratio design target of the engine.

As shown in FIG. 3, the engine as shown in FIGS. 1 and 2 may be mounted such that the high pressure turbine 54 is supported on a rear end by a mid-turbine frame 110. The mid-turbine frame 110 may be provided with a guide vane 112 that is an air turning vane. Since the high pressure turbine 54 and the low pressure or fan drive turbine 46 rotate in opposed directions, the use of the turning vane intermediate the two will ensure that the gases leaving the high pressure turbine 54 approach the low pressure turbine 46 traveling in the proper direction. As is clear from FIG. 3, the mid-turbine frame 110 also includes a bearing 116 which supports a shaft that rotates with the low spool 30 in an “overhung” manner. That is, the bearing 116 is at an intermediate position on the shaft, rather than adjacent the end.

Static structure 102 and 108 support other bearings 100 and 110 to support the shafts driven by spools 30 and 32 on the compressor end. The high pressure turbine 54 can be said to be “straddle-mounted” due to the bearings 110 and 114 on the outer periphery of the shaft 32.

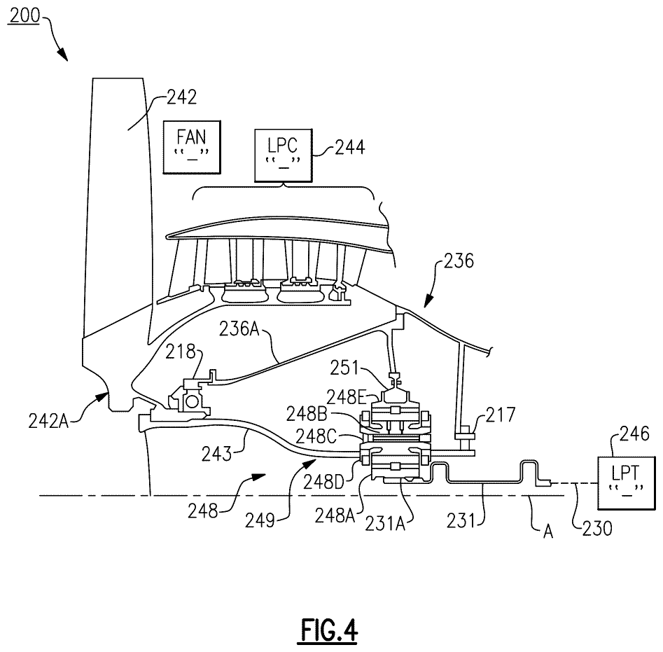

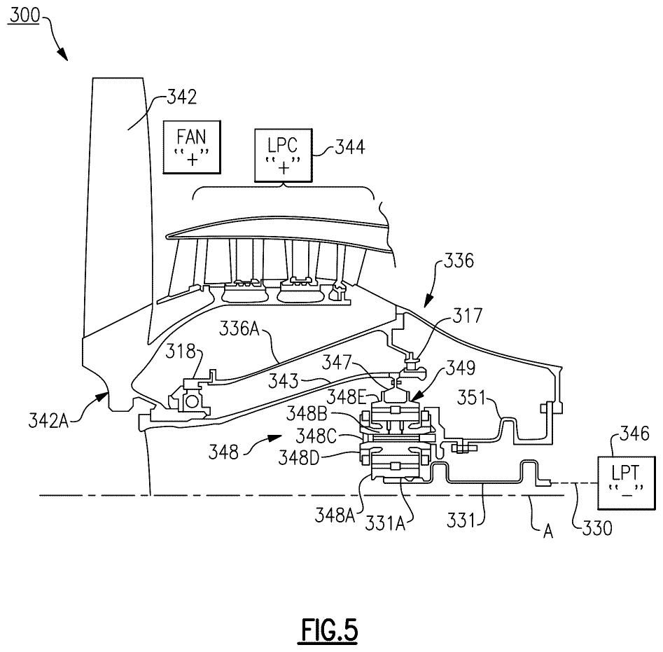

FIG. 4 shows an embodiment 200, having a gear reduction 248 intermediate a low pressure (or first) compressor section 244 and a shaft 230 driven by a low pressure turbine section 246. Embodiment 200 can be utilized and/or combined with the features of the engine 20 as shown in FIGS. 1 to 3, for example, with like reference numerals designating like elements where appropriate and reference numerals with the addition of one-hundred or multiples thereof designating modified elements that are understood to incorporate the same features and benefits of the corresponding original elements.

The gear reduction 248 includes a sun gear 248A attached to the shaft 230. The sun gear 248A can be mounted to a flexible input 231 which is attached to the shaft 230. The gear reduction 248 can include a spline interface 231A, in which flexible input 231 has a spline which mates with and engages an inner periphery of the sun gear 248A. Accordingly, the sun gear 248A can be driven by the spline interface 231A of the flexible input 231. Surrounding the sun gear 248A is a plurality of planet gears 248B supported on bearings 248C attached to a carrier 248D mounted to a fan drive shaft 243. The planet gears 248B are surrounded on a radially outward side by a ring gear 248E. The fan drive shaft 243 interconnects an output 249 of the gear reduction 248 and the fan 242, with the fan 242 and the low pressure compressor section 244 being driven by the output 249 of the gear reduction 248. In the illustrated embodiment of FIG. 4, the output 249 is the carrier 248D of the gear reduction 248, with the carrier 248D being rotatable about the engine axis A and the ring gear 248E being fixed. The low pressure compressor 244 can be driven by the shaft 230 such that the low pressure compressor 244 and the low pressure turbine 246 are rotatable at a common speed and a common direction. In another example, the fan 242 and the low pressure compressor section 244 are coupled to the gear reduction 248 such that the fan 242 and the low pressure compressor section 244 are rotatable at different speeds and/or in different directions.

The ring gear 248E can be attached to the engine static structure 236 through a flexible support 251 which at least partially supports the gear reduction 248. The static structure 236 includes a bearing support or frame 236A which supports at least a portion of the fan drive shaft 243 via a fan shaft roller bearing 217 and a fan shaft thrust bearing 218. The gear reduction 248 connects to the fan drive shaft 243 axially forward of the fan shaft roller bearing 217 and axially rearward of the fan shaft thrust bearing 218 in order to allow the gear reduction 248 to be at least partially axially aligned with the low pressure compressor 244. Alternatively, the fan shaft roller bearings 217 could be located axially forward of the gear reduction 248 and the fan shaft thrust bearing 218 could be located axially aft of the gear reduction 248. The bearings 217 and 218 are positioned on opposite sides of the gear reduction 248 relative to engine axis A and support the gear reduction 248 in a “straddle-mounted” manner. In the illustrated embodiment of FIG. 4, the fan shaft roller bearing 217 supports an aft portion of the carrier 248D.

The frame 236A defines a frame lateral stiffness and a frame transverse stiffness. It should be understood that the term “lateral” as defined herein is generally transverse to the engine axis A, and the term “transverse” refers to a pivotal bending movement with respect to the engine axis A which typically absorbs deflection applied to the gear reduction 248. The flexible input 231 and the flexible support 251 each can be arranged to define a respective support/input lateral stiffness and a support/input transverse stiffness.

In examples, the support transverse stiffness and/or the input transverse stiffness are less than the frame transverse stiffness. In some examples, the support lateral stiffness and/or the input lateral stiffness are less than the frame transverse stiffness. In one example, both the support lateral stiffness and the input lateral stiffness are less than about 80% of the frame lateral stiffness, or more narrowly less than about 50%, with the lateral stiffness of the entire gear reduction 248 being controlled by this lateral stiffness relationship. Alternatively, or in addition to this relationship, both the support transverse stiffness and the input transverse stiffness are each less than about 80% of the frame transverse stiffness, or more narrowly between 80% and 50%, less than about 65%, or less than about 50%, with the transverse stiffness of the entire gear reduction 248 being controlled by this transverse stiffness relationship. In some examples, the support lateral stiffness and/or the input lateral stiffness are less than about 20% of the frame lateral stiffness. In other examples, the support transverse stiffness and/or the input transverse stiffness are less than about 20% of the frame transverse stiffness.

FIG. 5 shows an embodiment 300 with gear reduction 348. In the illustrated example of FIG. 5, the output 349 is the ring gear 348E, with the fan drive shaft 343 mechanically attached to a fan rotor 342A of the fan 342 such that the fan 342 and the low pressure compressor section 344 are rotatable at a common speed and in a common direction. The carrier 348D is attached to the engine static structure 336 through a flexible support 351. The gear reduction 348 includes a flexible output coupling 247 which interconnects output 249 of the gear reduction 348 and the fan drive shaft 343. The flexible input 331, the flexible output coupling 347, and the flexible support 351 work together to maintain alignment of the gear reduction 348 and can facilitate the segregation of vibrations and other transients between the various components during operation of the gas turbine engine 20.

While this invention has been disclosed with reference to one embodiment, it should be understood that certain modifications would come within the scope of this invention. For that reason, the following claims should be studied to determine the true scope and content of this invention.

What is claimed is:

1. A gas turbine engine comprising:
a propulsor including a plurality of blades;
a compressor section including a first compressor and a second compressor, and the first compressor including a plurality of stages, and the second compressor including a plurality of stages;
a turbine section including a first turbine and a second turbine, wherein the first turbine drives the second compressor, and the second turbine includes three stages;
an epicyclic gear system with a gear reduction, wherein the second turbine drives the propulsor through the epicyclic gear system, wherein the epicyclic gear system includes a sun gear, a plurality of intermediate gears surrounding the sun gear, and a ring gear surrounding the intermediate gears, and wherein the gear system is a planetary gear system including a carrier that supports the intermediate gears;
a drive shaft interconnecting the carrier and the propulsor;
a frame supporting at least a portion of the drive shaft, the frame defining a frame transverse stiffness and a frame lateral stiffness;
a flexible support at least partially supporting the gear system relative to an engine static structure, the flexible support defining a support transverse stiffness with respect to the frame transverse stiffness and a support lateral stiffness with respect to the frame lateral stiffness; and
wherein the support transverse stiffness is between 50% and 80% of the frame transverse stiffness, and the support lateral stiffness is at least 20% but less than 80% of the frame lateral stiffness;
wherein the second turbine has a first exit area at a first exit point and is rotatable at a first speed, the second turbine has a second exit area at a second exit point and is rotatable at a second speed, the second speed being greater than twice the first speed; and
wherein a first performance quantity is defined as the product of the first speed squared and the first exit area, a second performance quantity is defined as the product of the second speed squared and the second exit area, and a performance ratio of the first performance quantity to the second performance quantity is between 0.8 and 1.5.

2. The gas turbine engine as set forth in claim 1, wherein the performance ratio is between 1.0 and 1.075.

3. The gas turbine engine as set forth in claim 1, wherein the first compressor includes three stages.

4. The gas turbine engine as set forth in claim 3, wherein the first compressor includes fewer stages than the second turbine.

5. The gas turbine engine as set forth in claim 1, wherein the epicyclic gear system is straddle-mounted by first and second bearings on opposite sides of the gear reduction relative to an engine longitudinal axis, the first bearing supports the drive shaft, and the second bearing supports an aft portion of the carrier.

6. The gas turbine engine as set forth in claim 5, wherein the performance ratio is between 1.0 and 1.075.

7. The gas turbine engine as set forth in claim 5, wherein the first compressor includes three stages.

8. The gas turbine engine as set forth in claim 5, wherein the second bearing is axially aligned with the carrier relative to the engine longitudinal axis.

9. The gas turbine engine as set forth in claim 5, wherein the second bearing is situated along an outer periphery of the carrier.

10. The gas turbine engine as set forth in claim 5, wherein the first bearing is a thrust bearing, the second bearing is a roller bearing.

11. The gas turbine engine as set forth in claim 1, wherein the gas turbine engine includes a first spool and a second spool, wherein the first spool includes a first shaft that interconnects the propulsor, the first compressor and the second turbine, wherein the second spool includes a second shaft that interconnects the second compressor and the first turbine, and wherein the first shaft and the second shaft are rotatable about the engine longitudinal axis.

12. The gas turbine engine as set forth in claim 11, further comprising a mid-turbine frame positioned intermediate the first turbine and the second turbine, and the mid-turbine frame has a bearing supporting the first shaft.

13. The gas turbine engine as set forth in claim 12, wherein the mid-turbine frame includes a guide vane positioned intermediate the first turbine and the second turbine, and the guide vane being an air turning guide vane.

14. The gas turbine engine as set forth in claim 12, wherein the bearing of the mid-turbine frame supports the first shaft in an overhung manner.

15. The gas turbine engine as set forth in claim 1, wherein the sun gear is mounted to a flexible input attached to the first shaft.

16. The gas turbine engine as set forth in claim 1, wherein the support transverse stiffness is less than 65% of the frame transverse stiffness.

17. The gas turbine engine as set forth in claim 1, wherein the support lateral stiffness is less than 50% of the frame lateral stiffness.

18. The gas turbine engine as set forth in claim 17, wherein the support transverse stiffness is less than 65% of the frame transverse stiffness.

19. The gas turbine engine as set forth in claim 18, wherein the performance ratio is between 1.0 and 1.075.

20. The gas turbine engine as set forth in claim 1, wherein the gear reduction is positioned between the first compressor and the second turbine such that the propulsor and the first compressor are rotatable at a common speed.
